(19) United States
(12) Patent Application Publication
(10) Pub. No.: US 2025/0294312 A1
(43) Pub. Date: Sep. 18, 2025

(54) WRITING TO A TERRITORY ASSIGNMENT FILE USING GEOSPATIAL RELATIONSHIPS

(71) Applicant: Capital One Services, LLC, McLean, VA (US)

(72) Inventors: Vidhya PRABHU, McKinney, TX (US); Albert NABIULLIN, McLean, VA (US); Kishore Babu DOPPALAPUDI, Frisco, TX (US); Andrew BRUNTS, Dallas, TX (US); Sikkandar PACKIAM, McKinney, TX (US); Raghuram VIJAYARAGHAVAN, Little Elm, TX (US)

(21) Appl. No.: 18/602,217

(22) Filed: Mar. 12, 2024

(51) Int. Cl. H04W 4/021; G01C 21/34; G06F 16/9038; G06F 16/909

(52) U.S. Cl. CPC H04W 4/021; G01C 21/343; G06F 16/9038; G06F 16/909

(57) ABSTRACT

In some implementations, a device may retrieve assignment data indicating territory assignments of a plurality of entities to a plurality of territories. The entities may have physical addresses in a plurality of serviced locations, and an entity may lack a territory assignment. The device may identify, for the serviced locations, respective travel times between the serviced locations and a location relating to a physical address for the entity. The device may identify a set of nearest entities in an order of travel proximity to the location according to the respective travel times. The device may monitor, during identifying of the set of nearest entities and in accordance with the territory assignments, respective counts of nearest entities for the plurality of territories, until a count of nearest entities for a territory satisfies a threshold. The device may generate updated assignment data to indicate an assignment of the entity to the territory.

### BACKGROUND

A file path may describe a location of a physical file in a file structure of a data storage device. Physical files contain the actual data that is stored on the data storage device, and a description of how data is to be presented to or received from a program. An application may store data in a physical file. For example, the application may store a reference to a file path associated with the physical file and may write data to the physical file via the file path.

### SUMMARY

Some implementations described herein relate to a system for writing to a territory assignment file using geospatial relationships. The system may include one or more memories and one or more processors communicatively coupled to the one or more memories. The one or more processors may be configured to retrieve, from a first data structure, entity data indicating a plurality of entities that are to have territory assignments to a plurality of territories of a region. The one or more processors may be configured to scan the entity data to identify an entity, of the plurality of entities, that lacks a territory assignment, where the entity data indicates a physical address for the entity. The one or more processors may be configured to retrieve, from a second data structure, assignment data indicating the territory assignments of the plurality of entities to respective territories of the plurality of territories, where the plurality of entities have physical addresses in a plurality of serviced locations. The one or more processors may be configured to identify, for the plurality of serviced locations, respective travel times between the plurality of serviced locations and a location relating to the physical address. The one or more processors may be configured to compile a list of nearest entities, of the plurality of entities, in an order of travel proximity to the location according to the respective travel times. The one or more processors may be configured to monitor, during compilation of the list of nearest entities and in accordance with the territory assignments, respective counts of nearest entities for the plurality of territories, until a count of nearest entities for a territory, of the plurality of territories, satisfies a threshold. The one or more processors may be configured to retrieve the territory assignment file from a cloud storage location. The one or more processors may be configured to write, to the territory assignment file, updated assignment data indicating an assignment of the entity to the territory.

Some implementations described herein relate to a method of updating a territory assignment using geospatial relationships. The method may include retrieving assignment data indicating territory assignments of a plurality of entities to respective territories of a plurality of territories of a region, where the plurality of entities have physical addresses in a plurality of serviced locations, and where an entity, of the plurality of entities, lacks a territory assignment. The method may include identifying, for the plurality of serviced locations, respective travel times between the plurality of serviced locations and a location relating to a physical address for the entity. The method may include identifying a set of nearest entities, of the plurality of entities, in an order of travel proximity to the location according to the respective travel times. The method may include monitoring, during identifying of the set of nearest entities and in accordance with the territory assignments, respective counts of nearest entities for the plurality of territories, until a count of nearest entities for a territory, of the plurality of territories, satisfies a threshold. The method may include generating updated assignment data to indicate an assignment of the entity to the territory.

Some implementations described herein relate to a non-transitory computer-readable medium that stores a set of instructions for updating a territory assignment using geospatial relationships. The set of instructions, when executed by one or more processors of a device, may cause the device to retrieve assignment data indicating territory assignments of a plurality of entities to respective territories of a plurality of territories of a region, where the plurality of entities have physical addresses in a plurality of serviced locations, and where an entity, of the plurality of entities, lacks a territory assignment. The set of instructions, when executed by one or more processors of the device, may cause the device to identify, for the plurality of serviced locations, respective travel times between the plurality of serviced locations and a location relating to a physical address for the entity. The set of instructions, when executed by one or more processors of the device, may cause the device to identify a set of nearest entities, of the plurality of entities, in an order of travel proximity to the location according to the respective travel times. The set of instructions, when executed by one or more processors of the device, may cause the device to monitor, during identification of the set of nearest entities and in accordance with the territory assignments, respective counts of nearest entities for the plurality of territories, until a count of nearest entities for a territory, of the plurality of territories, satisfies a threshold. The set of instructions, when executed by one or more processors of the device, may cause the device to transmit, for a user device of a user that services the territory, a notification indicating an assignment of the entity to the territory.

### BRIEF DESCRIPTION OF THE DRAWINGS

FIGS. 1A-1F are diagrams of an example associated with updating territory assignments, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with updating territory assignments, in accordance with some embodiments of the present disclosure.

FIG. 4 is a flowchart of an example process associated with updating territory assignments, in accordance with some embodiments of the present disclosure.

### DETAILED DESCRIPTION

The following detailed description of example implementations refers to the accompanying drawings. The same reference numbers in different drawings may identify the same or similar elements.

An organization may store vast amounts of data in electronic files or other data structures. The data stored by an organization may be in need of frequent updates in order to keep the data current. For example, the data may indicate territory assignments of entities to territories (e.g., sales territories), which can be updated from time to time as new entities are onboarded or as entities exit. In some cases, updates to the data may be handled manually using programmatic methods, database queries, or the like. Such techniques are complex, time-consuming, and prone to errors. Due to these drawbacks, the data may go without updates for lengthy time periods, resulting in stale and inaccurate data. As a result, downstream processes that may use the inaccurate data can be negatively affected. For example, the inaccurate data may produce error states, may be ineffectively used in further processing or computation, and/or may lead to corruption of other related data, thereby consuming excessive computing resources and/or impacting data or system integrity.

Some implementations described herein enable automated data updating to improve data freshness. In some implementations, the data may be stored in a territory assignment file that indicates territory assignments of entities to territories. After a new entity is onboarded, an automated process may execute to automatically provide a territory assignment for the new entity, thereby ensuring that the data is current. The territory assignment for the new entity may be based on geospatial relationships between a location (e.g., of a place of business) of the new entity and locations of entities that already have territory assignments. In this way, a suitable territory assignment can be identified automatically, thereby enabling current data to be efficiently maintained. Accordingly, the automated updating of the data provides improved accuracy of the data, which improves downstream uses of the data, conserves computing resources associated with downstream uses of the data, and maintains data or system integrity in connection with uses of the data.

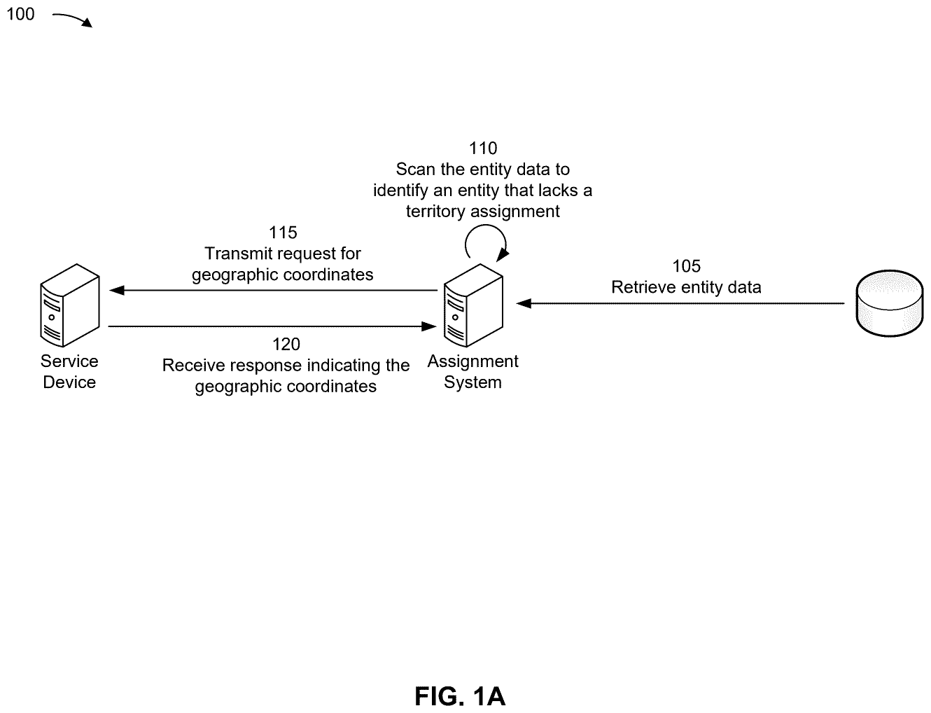

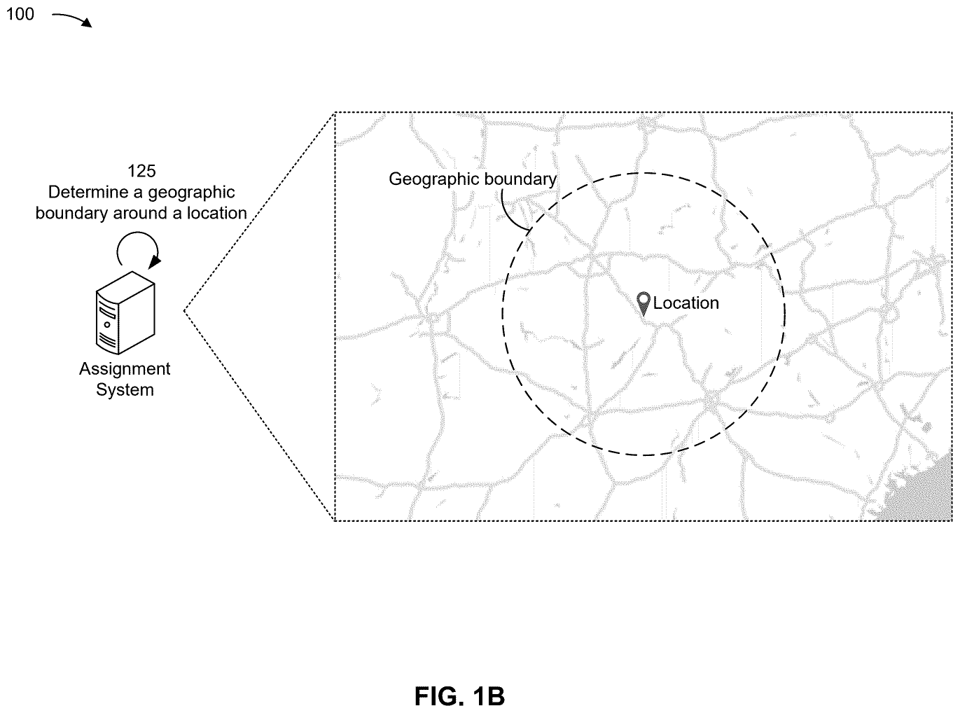

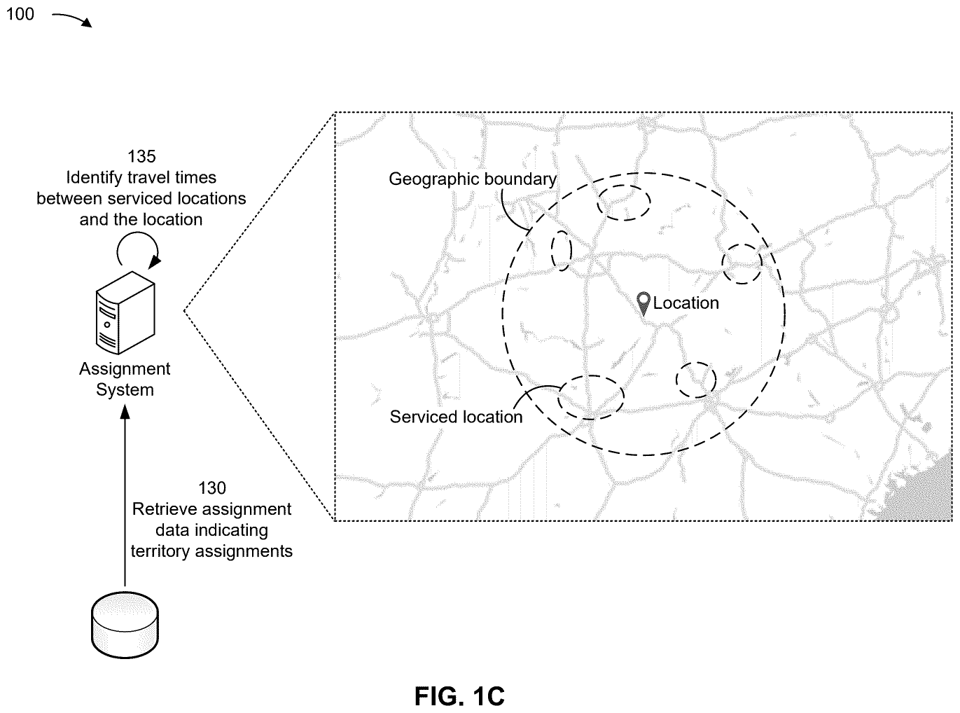

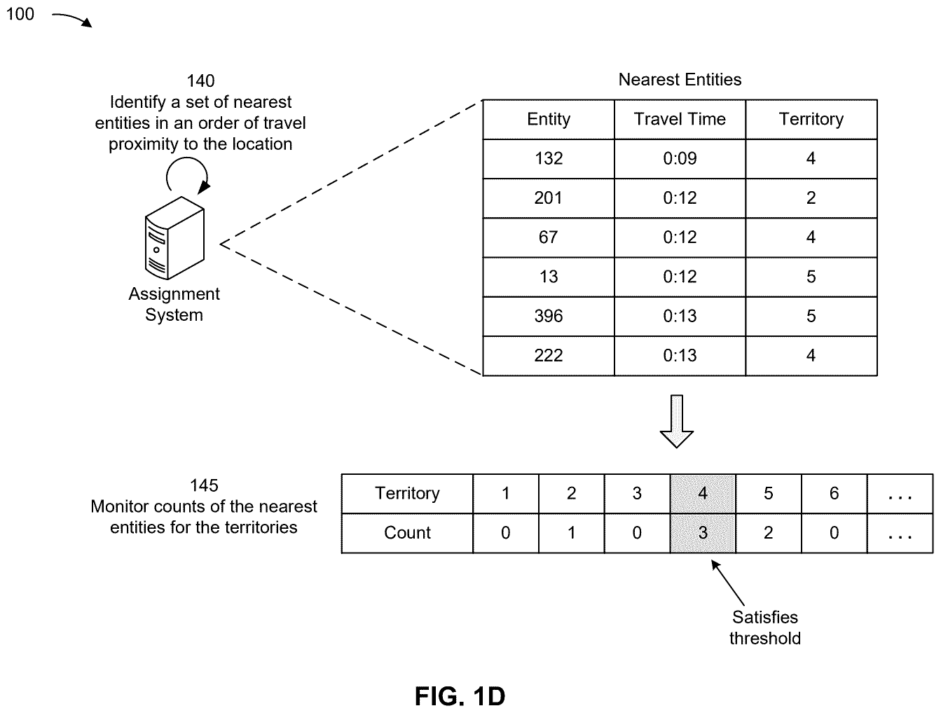

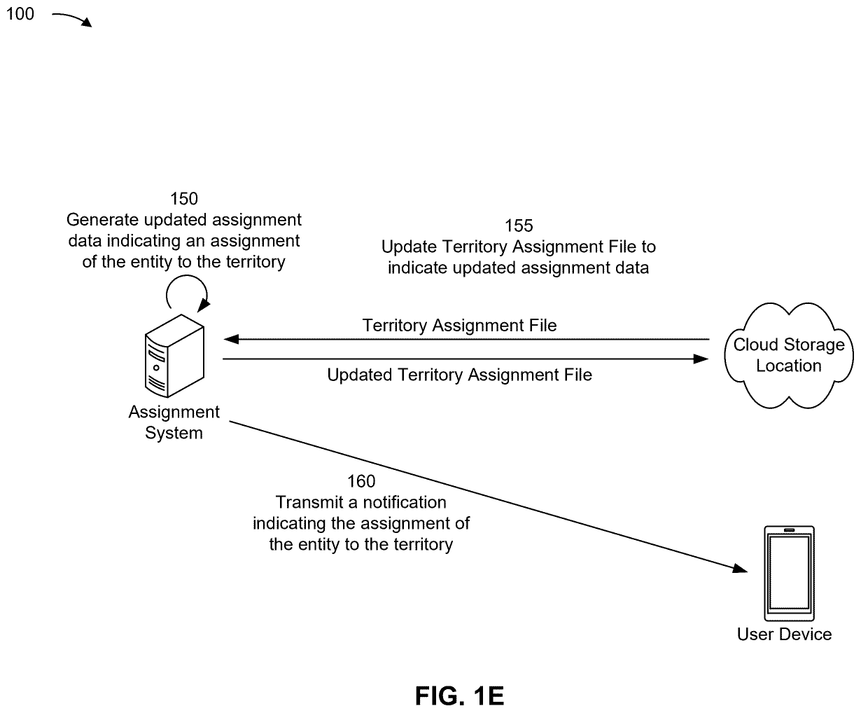

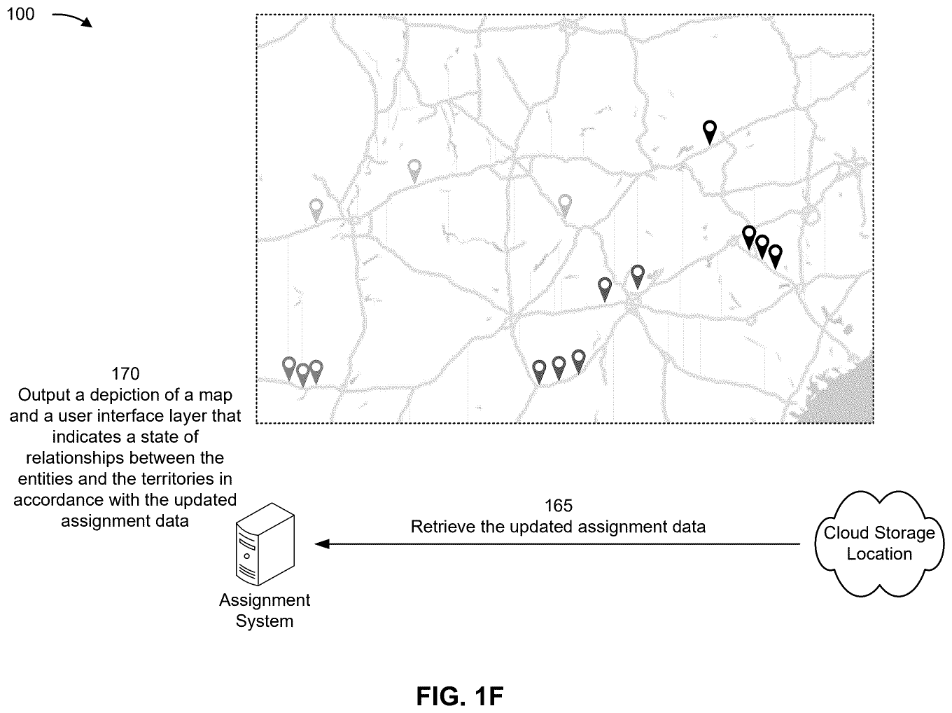

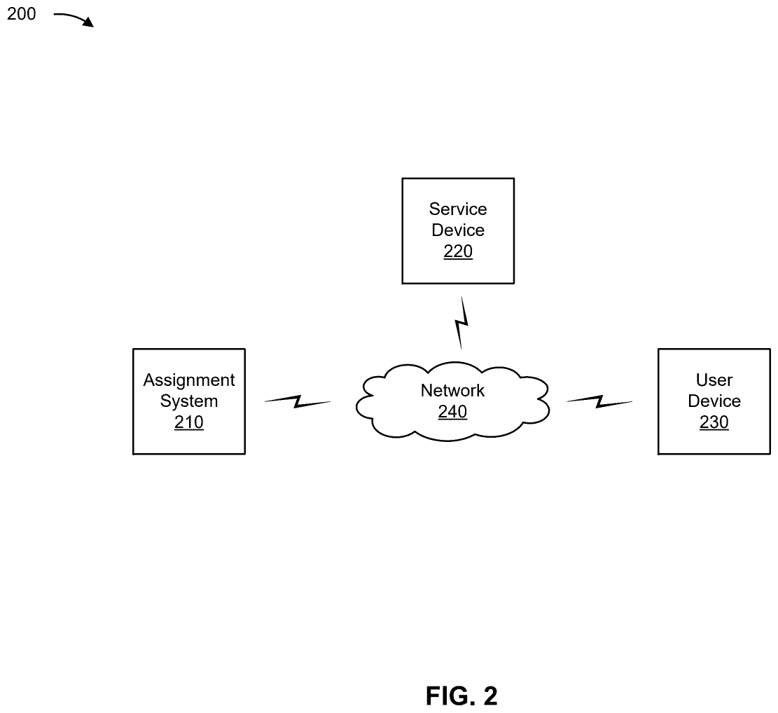

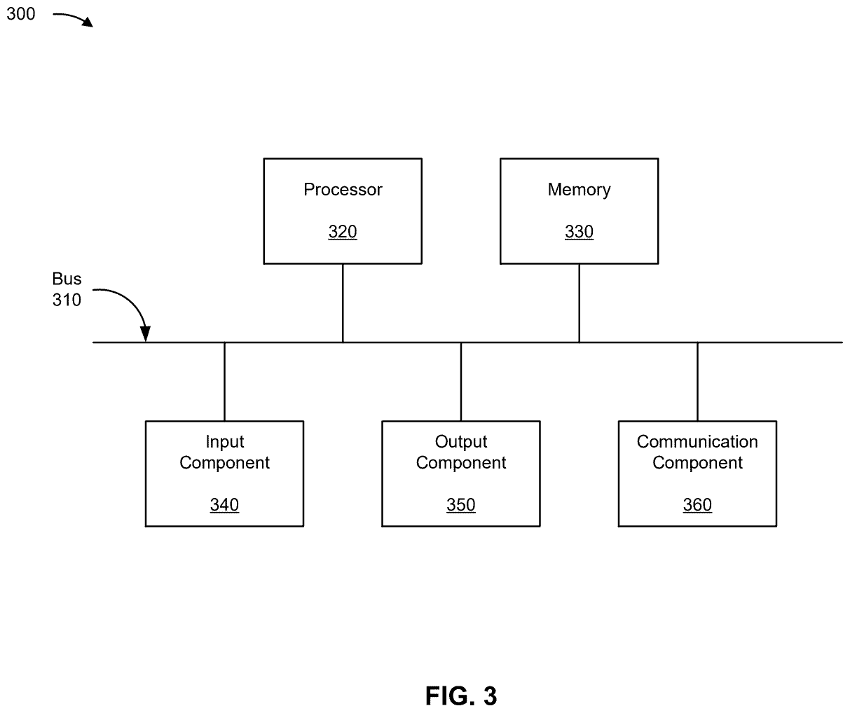

FIGS. 1A-1F are diagrams of an example 100 associated with updating territory assignments. As shown in FIGS. 1A-1F, example 100 includes an assignment system, a service device, and a user device. These devices are described in more detail in connection with FIGS. 2 and 3.

The assignment system may provide automatic updating of assignments for a plurality of territories within a region (e.g., a country-level region, a state-level region, a city-level region, or the like). “Territory” may refer to a virtual area within the region that includes one or more entities (e.g., business entities, customers, or the like) that are associated with (e.g., served by, managed by, or the like) a representative (e.g., a sales manager) for the territory. For example, a territory may be defined by the entities that are associated with the territory, rather than by a geographical region (e.g., based on the entities associated with a territory, the territory may encompass a contiguous or a non-contiguous geographical region). In some implementations, an entity may be a car dealership. In some implementations, the representatives may represent an organization that provides financing to customers of the car dealership to facilitate transactions. Thus, the representatives may seek to establish relationships with the car dealerships in connection with the financing provided by the organization. The user device may be associated with a user, such as a representative that services a territory.

The assignment system may implement a process (e.g., an application, a service, or the like) that handles updating of territory assignments. The assignment system may execute the process periodically (e.g., once a week, once a month, or the like). Alternatively, the assignment system may execute the process in response to detection of an execution event. For example, the assignment system may monitor a set of records relating to entities managed by the assignment system to detect when a record for a new entity has been added, and the assignment system may execute the process in response to detection of the record of the new entity. In some implementations, the territory assignments updated by the assignment system may be indicated in a territory assignment file (e.g., any electronic document or electronic data structure capable of persisting information indicating a mapping of entities to territories). The territory assignment file may be stored in a cloud storage location, such as a cloud-based data warehouse or another cloud-based data repository, thereby providing centralized availability of the territory assignment file.

In connection with execution of the process, as shown in FIG. 1A, and by reference number 105, the assignment system may retrieve entity data indicating a plurality of entities that are to have territory assignments to the plurality of territories of the region (e.g., one or more of the entities may already have territory assignments and/or one or more of the entities may be in need of territory assignments). The assignment system may retrieve the entity data from a first data structure (e.g., a database, a table, or the like). The entity data may indicate general-purpose information about the plurality of entities, such as entity names, physical addresses, telephone numbers, email addresses, or the like.

As shown by reference number 110, the assignment system may scan the entity data to identify an entity, of the plurality of entities, that lacks a territory assignment (referred to herein as the “unassigned entity”). The entity data may not indicate whether the entities have territory assignments. Accordingly, the assignment system may identify that the unassigned entity lacks a territory assignment using other information. For example, the assignment system may scan the entity data by comparing times that the entities were added to the entity data to a time of a last execution of the process. An entity that was added after the time of the last execution of the process may therefore lack a territory assignment (e.g., because execution of the process automatically provides territory assignments). In other words, the unassigned entity may be a newly added entity since a last execution of the process.

In some implementations, while scanning the entity data, the assignment system may identify one or more entities that are to be removed from the assignment system (e.g., due to the entities no longer participating in a financing program offered by the organization). In response to identifying the one or more entities, the assignment system may update the territory assignment file to remove territory assignments associated with the one or more entities. As an example, the assignment system may retrieve the territory assignment file and delete the territory assignments associated with the one or more entities from the territory assignment file.

As shown by reference number 115, the assignment system may transmit a request for geographic coordinates relating to a physical address of the unassigned entity (e.g., the request may indicate the physical address). For example, the assignment system may transmit the request to the service device via an application programming interface (API) endpoint. The API endpoint may expose a maps service, a location service, a geographic information system (GIS) service, or the like, implemented by the service device. As shown by reference number 120, the assignment system may receive, from the service device via the API endpoint, a response indicating the geographic coordinates. The geographic coordinates may include latitude and longitude coordinates or another type of geographic coordinates. In some implementations, the assignment system may store (e.g., in a data structure, such as a database) information that associates the geographic coordinates with the unassigned entity.

As shown in FIG. 1B, and by reference number 125, the assignment system may determine, based on a location relating to the physical address of the unassigned entity, a geographic boundary around the location. The location relating to the physical address of the unassigned entity may correspond to the geographic coordinates obtained from the service device or may be the physical address itself. In some implementations, the assignment system may determine the geographic boundary by multiplying the geographic coordinates by a scaling factor (e.g., 1.5 or the like). As an example, the geographic boundary may a circular boundary centered on the location and having a radius of approximately 100 miles, 150 miles, 200 miles, or the like.

As shown in FIG. 1C, and by reference number 130, the assignment system may retrieve assignment data indicating the territory assignments of the plurality of entities to respective territories of the plurality of territories. For example, the entities that are assigned to a territory may define an extent of the territory. Generally, the entities assigned to a territory are geographically clustered. The assignment system may retrieve the assignment data from a second data structure (e.g., a database, a table, or the like). The plurality of entities may have physical addresses in a plurality of serviced locations. A serviced location may be a location that is part of a territory that is currently being served by a representative. A serviced location may be a particular address, a zip code region (e.g., a region identified by a zip code), a city, a county, or the like. For example, the serviced locations may be zip code regions that contain the physical addresses of the entities.

As shown by reference number 135, the assignment system may identify, for the serviced locations, respective travel times (e.g., travel time estimates) between the serviced locations and the location relating to the physical address of the unassigned entity. In one example, the serviced locations are the physical addresses of the entities, and the assignment system may identify a respective travel time for each entity. In another example, the serviced locations are zip code regions, and the assignment system may identify a respective travel time for each zip code region, which can be used as an approximate travel time for each of the entities in the zip code region.

In some implementations, the assignment system may identify the respective travel times for only the serviced locations within the geographic boundary. For example, the assignment system may filter the serviced locations into a subset of serviced locations within the geographic boundary by comparing geographic coordinates of the serviced locations to geographic coordinates defining the geographic boundary.

In some implementations, a serviced location may be represented by a central point (e.g., a geographic center) of the serviced location (e.g., a central point of a zip code region). For example, for a zip code region, the assignment system may obtain (e.g., from the API endpoint, in a similar manner as described above) a set of geographic coordinates (e.g., latitude and longitude coordinates) that define geographic boundaries of the zip code region, which define a polygon. Continuing with the example, the assignment system may compute a centroid of the polygon, which indicates the geographic coordinates of the central point of the zip code region.

The travel time may include a driving time and/or public transportation travel time (e.g., by bus, subway, train, or the like). To identify a travel time between a serviced location and the location, the assignment system may transmit a request for the travel time (e.g., the request may indicate the service location and the location). For example, the assignment system may transmit the request to the service device via the API endpoint. The assignment system may receive, from the service device via the API endpoint, a response indicating the travel time. In some implementations, the assignment system may identify the travel time by computing the travel time. The assignment system may compute the travel time using map data indicating information relating to roads, intersections, speed limits, and/or other geographical features, and by computing an optimal route between the service location and the location. The travel time may be based on the optimal route, factoring in traffic data and/or speed data relating to the optimal route.

As shown in FIG. 1D, and by reference number 140, the assignment system may identify a set of nearest entities, of the plurality of entities, in an order of travel proximity to the location according to the identified travel times. For example, the assignment system may compile a list of the nearest entities in an order of travel proximity to the location according to the identified travel times. In one example, the assignment system has identified a respective travel time for each entity, and an entity with a shortest travel time may be first in order, an entity with a second-shortest travel time may be second in order, and so forth. In another example, the assignment system has identified a respective travel time for each zip code region, and one or more entities in a first zip code region with a shortest travel time may be first in order, one or more entities in a second zip code region with a second-shortest travel time may be second in order, and so forth.

As shown by reference number 145, during identification of the set of nearest entities (e.g., during compilation of the list of nearest entities) and in accordance with the territory assignments indicated by the assignment data, the assignment system may monitor respective counts of the nearest entities for the plurality of territories. For example, a count for a territory may be incremented when an entity, having a territory assignment to the territory, is added to the set of nearest entities. The assignment system may continue to monitor the counts until a count for a territory satisfies a threshold. In other words, the assignment system may monitor a race among the territories to reach the threshold. The count for the territory satisfying the threshold may indicate that the unassigned entity should be assigned to the territory (e.g., because the territory includes other nearby entities to the unassigned entity). In some implementations, the assignment system may use a machine learning model (e.g., trained to cluster entities using a clustering technique, such as K-means clustering) to identify a territory to which the unassigned territory can be assigned.

As shown in FIG. 1E, and by reference number 150, the assignment system may generate updated assignment data indicating an assignment of the entity to the territory. The updated assignment data may indicate information indicating the assignment of the entity to the territory appended to information indicating the other previously-established territory assignments of entities to territories. Alternatively, the updated assignment information may indicate only information indicating the assignment of the entity to the territory. As shown by reference number 155, the assignment system may update the territory assignment file to indicate the updated assignment data. As an example, the assignment system may retrieve the territory assignment file and write the updated assignment data to the territory assignment file. For example, the assignment system may retrieve the territory assignment file from a cloud storage location. In some implementations, after writing the updated assignment data to the territory assignment file, the assignment system may transmit the updated territory assignment file to the cloud storage location for storage. In this way, the territory assignment file is automatically updated and the data therein is kept current, thereby enabling real-time accuracy in downstream processes that use the territory assignment file as a source for input data.

As shown by reference number 160, the assignment system may transmit, for the user device, a notification indicating the assignment of the entity to the territory, thereby providing a real-time territory assignment update. In some implementations, the notification, or a separate communication transmitted by the assignment system for the user device, may indicate driving directions from a geographic location associated with the user/representative to respective geographic locations associated with entities assigned to the territory and/or may indicate an optimal route order in which the user/representative should visit the entities assigned to the territory (e.g., optimal for travel time, optimal for fuel efficiency, or optimal for generating sales, among other examples).

As shown in FIG. 1F, and by reference number 165, the assignment system may retrieve the updated assignment data (e.g., retrieve the territory assignment file and read the updated assignment data from the territory assignment file). For example, the assignment system may retrieve the updated assignment data in response to a request made by a user (e.g., via another application) to view a visualization of the territories. As shown by reference number 170, the assignment system may output, for presentation in a user interface, a depiction of a map of the region and a user interface layer, over the map, that indicates a state of relationships between the plurality of entities and the plurality of territories in accordance with the updated assignment data. For example, the user interface layer may include user interface elements (e.g., pins, as shown) that indicate locations of entities and territory assignments of the entities (e.g., through the use of different color pins to represent different territory assignments).

In some implementations, the user interface layer may further indicate contextual information associated with the updated assignment data. For example, the assignment system may obtain the contextual information from one or more data structures, such as one or more databases. The contextual information may include representative information for the territories (e.g., which may indicate identities and/or contact information for one or more representatives servicing the territory), values associated with the territories (e.g., annual sales revenues or the like), or other metrics associated with the territories (e.g., total travel distances between entities or the like), among other examples. In some implementations, the user interface layer may be configured to display the contextual information (e.g., in a pop-up element) associated with a territory responsive to a user interaction (e.g., clicking, hovering, or the like) with the territory on the map.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include an assignment system 210, a service device 220, a user device 230, and a network 240. Devices of environment 200 may interconnect via wired connections, wireless connections, or a combination of wired and wireless connections.

The assignment system 210 may include one or more devices capable of receiving, generating, storing, processing, providing, and/or routing information associated with updating territory assignments, as described elsewhere herein. The assignment system 210 may include a communication device and/or a computing device. For example, the assignment system 210 may include a server, such as an application server, a client server, a web server, a database server, a host server, a proxy server, a virtual server (e.g., executing on computing hardware), or a server in a cloud computing system. In some implementations, the assignment system 210 may include computing hardware used in a cloud computing environment.

The service device 220 may include one or more devices capable of receiving, generating, storing, processing, providing, and/or routing information associated with an information service (e.g., a maps service, a location service, a GIS service, or the like), as described elsewhere herein. The service device 220 may include a communication device and/or a computing device. For example, the service device 220 may include a server, such as an application server, a client server, a web server, a database server, a host server, a proxy server, a virtual server (e.g., executing on computing hardware), or a server in a cloud computing system. In some implementations, the service device 220 may include computing hardware used in a cloud computing environment.

The user device 230 may include one or more devices capable of receiving, generating, storing, processing, and/or providing information associated with territory assignments, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with updating territory assignments. The device 300 may correspond to the assignment system 210, the service device 220, and/or the user device 230. In some implementations, the assignment system 210, the service device 220, and/or the user device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

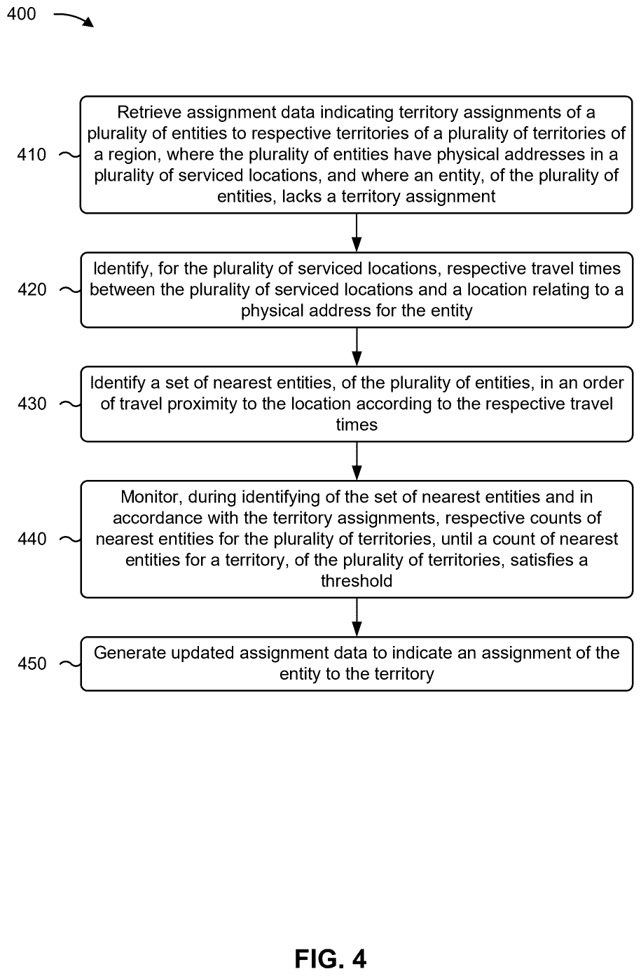

FIG. 4 is a flowchart of an example process 400 associated with updating territory assignments. In some implementations, one or more process blocks of FIG. 4 may be performed by the assignment system 210. In some implementations, one or more process blocks of FIG. 4 may be performed by another device or a group of devices separate from or including the assignment system 210, such as the service device 220 and/or the user device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include retrieving assignment data indicating territory assignments of a plurality of entities to respective territories of a plurality of territories of a region, where the plurality of entities have physical addresses in a plurality of serviced locations, and where an entity, of the plurality of entities, lacks a territory assignment (block 410). For example, the assignment system 210 (e.g., using processor 320, memory 330, and/or communication component 360) may retrieve assignment data indicating territory assignments of a plurality of entities to respective territories of a plurality of territories of a region, as described above in connection with reference number 130 of FIG. 1C. As an example, the serviced locations may be zip code regions that contain the physical addresses of the entities.

As further shown in FIG. 4, process 400 may include identifying, for the plurality of serviced locations, respective travel times between the plurality of serviced locations and a location relating to a physical address for the entity (block 420). For example, the assignment system 210 (e.g., using processor 320, memory 330, and/or communication component 360) may identify, for the plurality of serviced locations, respective travel times between the plurality of serviced locations and a location relating to a physical address for the entity, as described above in connection with reference number 135 of FIG. 1C. As an example, identifying the respective travel times may include transmitting one or more requests for the respective travel times via an API endpoint.

As further shown in FIG. 4, process 400 may include identifying a set of nearest entities, of the plurality of entities, in an order of travel proximity to the location according to the respective travel times (block 430). For example, the assignment system 210 (e.g., using processor 320 and/or memory 330) may identify a set of nearest entities, of the plurality of entities, in an order of travel proximity to the location according to the respective travel times, as described above in connection with reference number 140 of FIG. 1D. As an example, identifying the set of nearest entities may include compiling a list of the nearest entities in an order of travel proximity to the location according to the identified travel times.

As further shown in FIG. 4, process 400 may include monitoring, during identifying of the set of nearest entities and in accordance with the territory assignments, respective counts of nearest entities for the plurality of territories, until a count of nearest entities for a territory, of the plurality of territories, satisfies a threshold (block 440). For example, the assignment system 210 (e.g., using processor 320 and/or memory 330) may monitor, during identifying of the set of nearest entities and in accordance with the territory assignments, respective counts of nearest entities for the plurality of territories, until a count of nearest entities for a territory, of the plurality of territories, satisfies a threshold, as described above in connection with reference number 145 of FIG. 1D. As an example, a count for a territory may be incremented when an entity, having a territory assignment to the territory, is added to the set of nearest entities (or the list of nearest entities).

As further shown in FIG. 4, process 400 may include generating updated assignment data to indicate an assignment of the entity to the territory (block 450). For example, the assignment system 210 (e.g., using processor 320 and/or memory 330) may generate updated assignment data to indicate an assignment of the entity to the territory, as described above in connection with reference number 150 of FIG. 1E. As an example, once the updated assignment data is generated, a territory assignment file may be updated to indicate the updated assignment data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for writing to a territory assignment file using geospatial relationships, the system comprising:
one or more memories; and
one or more processors, communicatively coupled to the one or more memories, configured to:
retrieve, from a first data structure, entity data indicating a plurality of entities that are to have territory assignments to a plurality of territories of a region;
scan the entity data to identify an entity, of the plurality of entities, that lacks a territory assignment,
wherein the entity data indicates a physical address for the entity;
retrieve, from a second data structure, assignment data indicating the territory assignments of the plurality of entities to respective territories of the plurality of territories,
wherein the plurality of entities have physical addresses in a plurality of serviced locations;
identify, for the plurality of serviced locations, respective travel times between the plurality of serviced locations and a location relating to the physical address;
compile a list of nearest entities, of the plurality of entities, in an order of travel proximity to the location according to the respective travel times;
monitor, during compilation of the list of nearest entities and in accordance with the territory assignments, respective counts of nearest entities for the plurality of territories, until a count of nearest entities for a territory, of the plurality of territories, satisfies a threshold;
retrieve the territory assignment file from a cloud storage location; and
write, to the territory assignment file, updated assignment data indicating an assignment of the entity to the territory.

2. The system of claim 1, wherein the one or more processors are further configured to:
retrieve the territory assignment file to obtain the updated assignment data; and
output, for presentation in a user interface, a depiction of a map of the region and a user interface layer, over the map, that indicates a state of relationships between the plurality of entities and the plurality of territories in accordance with the updated assignment data.

3. The system of claim 1, wherein the one or more processors are further configured to:
transmit, for a user device of a user that services the territory, driving directions from a geographic location associated with the user to respective geographic locations associated with entities, of the plurality of entities, assigned to the territory.

4. The system of claim 1, wherein the one or more processors are further configured to:
transmit, via an application programming interface (API) endpoint, a request for geographic coordinates relating to the physical address; and
receive, via the API endpoint, a response indicating the geographic coordinates,
wherein the location corresponds to the geographic coordinates.

5. The system of claim 1, wherein the plurality of serviced locations are zip code regions that contain the physical addresses of the plurality of entities, and
wherein the one or more processors, to identify the respective travel times, are configured to:
identify the respective travel times between central points of the zip code regions and the location.

6. The system of claim 1, wherein the entity lacks the territory assignment due to being a newly added entity since a last execution of a process that handles updating of territory assignments.

7. The system of claim 1, wherein the one or more processors are configured to:
transmit, for a user device of a user that services the territory, a notification indicating the assignment of the entity to the territory.

8. A method of updating a territory assignment using geospatial relationships, comprising:
retrieving assignment data indicating territory assignments of a plurality of entities to respective territories of a plurality of territories of a region,
wherein the plurality of entities have physical addresses in a plurality of serviced locations, and
wherein an entity, of the plurality of entities, lacks a territory assignment;
identifying, for the plurality of serviced locations, respective travel times between the plurality of serviced locations and a location relating to a physical address for the entity;
identifying a set of nearest entities, of the plurality of entities, in an order of travel proximity to the location according to the respective travel times;
monitoring, during identifying of the set of nearest entities and in accordance with the territory assignments, respective counts of nearest entities for the plurality of territories, until a count of nearest entities for a territory, of the plurality of territories, satisfies a threshold; and
generating updated assignment data to indicate an assignment of the entity to the territory.

9. The method of claim 8, further comprising:
retrieving a territory assignment file from a cloud storage location; and
writing the updated assignment data to the territory assignment file.

10. The method of claim 9, further comprising:
retrieving the territory assignment file from the cloud storage location to obtain the updated assignment data; and
outputting, for presentation in a user interface, a depiction of a map of the region and a user interface layer, over the map, that indicates a state of relationships between the plurality of entities and the plurality of territories in accordance with the updated assignment data.

11. The method of claim 8, further comprising:
transmitting, for a user device of a user that services the territory, a notification indicating the assignment of the entity to the territory.

12. The method of claim 8, further comprising:
transmitting, via an application programming interface (API) endpoint, a request for geographic coordinates relating to the physical address; and
receiving, via the API endpoint, a response indicating the geographic coordinates,
wherein the location corresponds to the geographic coordinates.

13. The method of claim 8, further comprising:
transmitting, for a user device of a user that services the territory, a route order for visiting entities, of the plurality of entities, assigned to the territory.

14. The method of claim 8, wherein the plurality of entities are car dealerships.

15. A non-transitory computer-readable medium storing a set of instructions for updating a territory assignment using geospatial relationships, the set of instructions comprising:
one or more instructions that, when executed by one or more processors of a device, cause the device to:
retrieve assignment data indicating territory assignments of a plurality of entities to respective territories of a plurality of territories of a region,
wherein the plurality of entities have physical addresses in a plurality of serviced locations, and
wherein an entity, of the plurality of entities, lacks a territory assignment;
identify, for the plurality of serviced locations, respective travel times between the plurality of serviced locations and a location relating to a physical address for the entity;
identify a set of nearest entities, of the plurality of entities, in an order of travel proximity to the location according to the respective travel times;
monitor, during identification of the set of nearest entities and in accordance with the territory assignments, respective counts of nearest entities for the plurality of territories, until a count of nearest entities for a territory, of the plurality of territories, satisfies a threshold; and
transmit, for a user device of a user that services the territory, a notification indicating an assignment of the entity to the territory.

16. The non-transitory computer-readable medium of claim 15, wherein the one or more instructions, when executed by the one or more processors, further cause the device to:
transmit, via an application programming interface (API) endpoint, a request for geographic coordinates relating to the physical address; and
receive, via the API endpoint, a response indicating the geographic coordinates,
wherein the location corresponds to the geographic coordinates.

17. The non-transitory computer-readable medium of claim 15, wherein the one or more instructions, when executed by the one or more processors, further cause the device to:
retrieve a territory assignment file from a cloud storage location; and
write, to the territory assignment file, updated assignment data indicating the assignment of the entity to the territory.

18. The non-transitory computer-readable medium of claim 17, wherein the one or more instructions, when executed by the one or more processors, further cause the device to:
retrieve the territory assignment file from the cloud storage location to obtain the updated assignment data; and
output, for presentation in a user interface, a depiction of a map of the region and a user interface layer, over the map, that indicates a state of relationships between the plurality of entities and the plurality of territories in accordance with the updated assignment data.

19. The non-transitory computer-readable medium of claim 15, wherein the one or more instructions, that cause the device to identify the respective travel times, cause the device to:
transmit, via an application programming interface (API) endpoint, a request for a travel time between the location and a serviced location of the plurality of serviced locations; and
receive, via the API endpoint, a response indicating the travel time.

20. The non-transitory computer-readable medium of claim 15, wherein the one or more instructions, when executed by the one or more processors, further cause the device to:
determine, based on the location, a geographic boundary around the location, and
wherein the one or more instructions, that cause the device to identify, for the plurality of serviced locations, the respective travel times, cause the device to:
identify, for the plurality of serviced locations within the geographic boundary, the respective travel times.
